(19) United States
(12) Patent Application Publication
(10) Pub. No.: US 2017/0074387 A1
(43) Pub. Date: Mar. 16, 2017

(54) TRANSMISSION CASE

(71) Applicants: Toyota Jidosha Kabushiki Kaisha, Toyota-shi Aichi-ken (JP); Aisin AW Co., Ltd., Anjo-shi Aichi-ken (JP)

(72) Inventors: Yasuhiro Kawai, Toyota-shi Aichi-ken (JP); Seiji Hiroshima, Okazaki-shi Aichi-ken (JP); Satoshi Takahashi, Anjo-shi Aichi-ken (JP); Yuki Ito, Anjo-shi Aichi-ken (JP)

(21) Appl. No.: 15/264,120

(22) Filed: Sep. 13, 2016

(30) Foreign Application Priority Data
Sep. 15, 2015 (JP) 2015-182345

(51) Int. Cl. F16H 57/028; H01F 7/02

(52) U.S. Cl. CPC F16H 57/028; H01F 7/02

(57) ABSTRACT

A transmission case houses a gear mechanism that transmits power through the meshing of gears, the transmission case including an oil pan, the oil pan including a soft magnet in at least one portion thereof, the soft magnet being attached to the oil pan by magnetic attractive force.

### CROSS-REFERENCE TO RELATED APPLICATIONS

The present disclosure claims priority to Japanese Patent Application No. 2015-182345 filed on Sep. 15, 2015, which is incorporated herein by reference in its entirety including the specification, drawings and abstract.

### BACKGROUND

1. Technical Field

The present disclosure relates to a transmission case housing a gear mechanism that transmits power through the meshing of gears.

2. Description of Related Art

Generally, in a gear mechanism that transmits power through the meshing of gears, vibration is generated from the meshing part when the gears rotate in mesh to transmit power. Noise may be increased if this vibration excites resonance of the transmission case. Especially when a part of the transmission case is formed by the oil pan having a comparatively flat part, resonance of the oil pan often becomes a problem.

To address this problem, Japanese Patent Application Publication No. 2004-162754 discloses a technique that involves detachably mounting a weight member on a transmission case for the purpose of adjusting the resonance frequency range so as to suppress the resonance of the transmission case, and further involves selecting from weight members of various masses and attaching and detaching the selected ones.

### SUMMARY

However, the technique of JP 2004-162754 A requires a member for fixing the weight member to the transmission case. Moreover, if vibration outside an assumed range of resonance frequency occurs for some reason, the vibration suppressing effect on resonance to be generated is reduced, as well as the vibration suppressing effect on resonance already generated is small. One example is when excessive acceleration or deceleration beyond assumption is made.

Having been devised in the context of these circumstances, embodiments of the present disclosure realize noise reduction by suppressing the resonance of the transmission case housing a gear mechanism caused by vibration generated from the gear mechanism.

A first embodiment is a transmission case housing a gear mechanism that transmits power through the meshing of gears, the transmission case including an oil pan, the oil pan including a soft magnet in at least one portion thereof, the soft magnet being attached to the oil pan by magnetic attractive force.

According to the first embodiment, when the oil pan generates vibration due to resonance, the soft magnet attached thereto vibrates with the oil pan, while causing friction with an adhering surface, without entirely integrating with the oil pan. Part of the vibration energy of the oil pan is consumed by the friction energy generated in that process, so that the vibration of the oil pan is suppressed and noise generated from the oil pan is reduced.

A second embodiment is the transmission case according to the first embodiment, wherein the soft magnet may be attached to an inner surface of the oil pan.

According to the second embodiment, the soft magnet is attached to the inner side of the oil pan. Thus, even if the soft magnet drops from a predetermined position of the oil pan, the soft magnet remains inside the oil pan. Moreover, it is unlikely that the soft magnet comes off to the outside of the oil pan and causes damage to a device installed outside the vehicle transmission system.

A third embodiment is the transmission case according to the first or second embodiment, wherein the soft magnet may be attached to a position including at least a predetermined portion of the oil pan, and the predetermined portion may be a portion of the oil pan where a vibration amplitude before the installation of the soft magnet is maximum.

According to the third embodiment, the soft magnet is attached to a position including at least the portion of the oil pan where the vibration amplitude before the installation of the soft magnet is maximum. Thus, a larger amount of friction energy is generated by the soft magnet, so that vibration is effectively suppressed.

A fourth embodiment is the transmission case according to any one of the first to third embodiments, wherein the soft magnet may be a magnet made of a resin with magnetic powder dispersed therein.

According to the fourth embodiment, the soft magnet is a magnet made of a resin with magnetic powder dispersed therein. Thus, it is possible to increase the friction energy generated by the soft magnet by adjusting the bending elastic modulus (Kgf/mm²) and the hardness (HRM) of the soft magnet.

A fifth embodiment is the transmission case according to the fourth embodiment, wherein the soft magnet may be a soft magnet having a bending elastic modulus of 2500 Kgf/mm² or less or a Rockwell hardness of HRM 150 or less.

According to the fifth embodiment, vibration is suppressed effectively if the soft magnet is a soft magnet having a bending elastic modulus of 2500 (Kgf/mm²) or less or a Rockwell hardness of HRM 150 or less.

A sixth embodiment is the transmission case according to the fourth embodiment, wherein the soft magnet may be a soft magnet having a bending elastic modulus of 1500 Kgf/mm² or less or a Rockwell hardness of HRM 100 or less.

According to the sixth embodiment, vibration is suppressed more effectively if the soft magnet is a soft magnet having a bending elastic modulus of 1500 (Kgf/mm²) or less or a Rockwell hardness of HRM 100 or less.

A seventh embodiment is the transmission case according to the fourth embodiment, wherein the soft magnet may be a soft magnet having a bending elastic modulus of 1000 Kgf/mm² or less or a Rockwell hardness of HRM 50 or less.

According to the seventh embodiment, vibration is suppressed even more effectively if the soft magnet is a soft magnet having a bending elastic modulus of 1000 (Kgf/mm²) or less or a Rockwell hardness of HRM 50 or less.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic view illustrating the configuration of the major part of a transmission case according to one embodiment;

FIG. 2 is a characteristic diagram illustrating a vibration suppressing effect achieved by installing a hard magnet and a soft magnet;

FIG. 3 is a conceptual view illustrating the effect in the transmission case where the hard magnet is installed on an oil pan of FIG. 1;

FIG. 4 is a conceptual view illustrating the effect in the transmission case where the soft magnet is installed on the oil pan of FIG. 1;

FIG. 5 is a characteristic diagram illustrating a vibration suppressing effect achieved by increasing the mass of a part of the oil pan constituting a part of the transmission case of the transmission system of FIG. 1;

FIG. 6 is a front view of a test example of the oil pan of FIG. 1;

FIG. 7 is a front view of another test example of the oil pan of FIG. 1; and

FIG. 8 is a characteristic diagram illustrating a vibration suppressing effect according to the test examples of the oil pan of FIG. 6 and FIG. 7.

### DETAILED DESCRIPTION OF EMBODIMENTS

In the following, an embodiment of an oil pan constituting a part of a transmission case of the present disclosure will be described in detail with reference to the drawings.

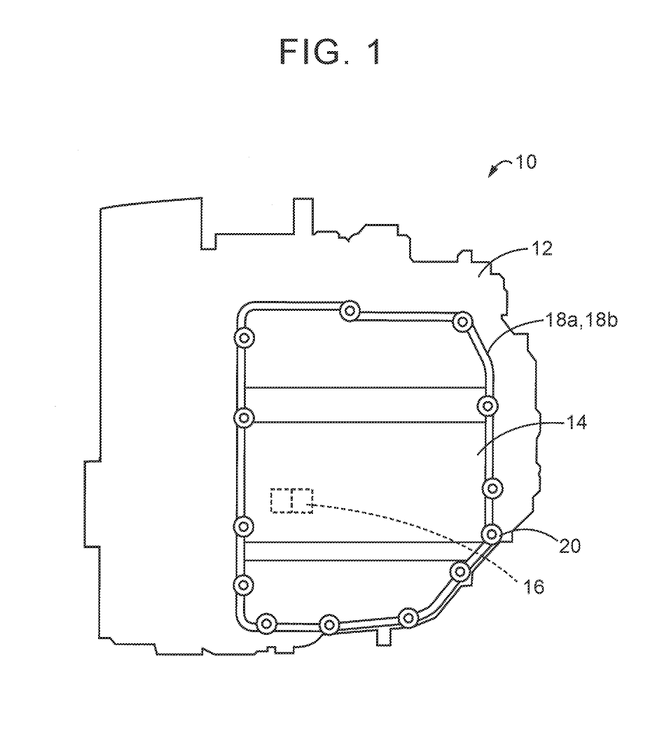

FIG. 1 is a schematic view of a transmission case 12 with the present disclosure suitably applied thereto, as seen from the front side of the vehicle. A transmission 10 transmits power and changes speed through the meshing of gears, and has a gear mechanism (not shown) housed inside the transmission case 12. An oil pan 14 constituting a part of the transmission case 12 has a tray-like shape. A joint surface 18a formed along the outer edge of the oil pan 14 is oil-tightly fastened with a plurality of bolts 20 while in contact with a joint surface 18b formed in the transmission case 12. In this embodiment, the oil pan 14 is disposed so as to be vertical to a bottom surface of the vehicle (not shown), i.e., such that the bottom of the tray-shaped oil pan 14 is vertical to the bottom surface of the vehicle. However, the oil pan 14 does not particularly need to be vertical but may be horizontal to the bottom surface of the vehicle, i.e., installed at the bottom of the transmission case 12. The material of the oil pan 14 is selected from ferromagnetic materials, such as iron-based metals, that allow a soft magnet 16b to be attached to the oil pan 14 by magnetic attractive force.

The soft magnet 16b has the shape of a plate segment, and, for example, two soft magnets 16b are installed side by side on the inner side of the oil pan 14, i.e., on the side of the gear mechanism housed inside the transmission case 12. However, two or more soft magnets may be attached in layers to enhance the vibration suppressing effect. When the soft magnet 16b is attached to the inner side of the oil pan 14, the oil pan 14 is oil-tight. Therefore, even if the soft magnet 16b drops from a predetermined position, the soft magnet 16b remains inside the oil pan 14. Thus, it is unlikely that the soft magnet 16b comes off to the outside of the oil pan 14 and causes damage to a device outside the transmission. It is not particularly necessary that the number of the soft magnets 16b is two; the size and the number, which is singular or plural, are selected such that the soft magnets 16b are easy to install in a place subjected to significant vibration as well as easy to handle.

Noise may be increased if the transmission case 12 resonates due to vibration from a meshing part of the gears. Especially when a part of the case is formed by the oil pan 14 having a comparatively flat part, the resonance of the oil pan 14 can become a problem. A place where the vibration amplitude of the oil pan 14 is maximum is selected as the installation position of the soft magnet 16b. In this embodiment, noise from the oil pan 14 is measured and the frequency is analyzed to determine the frequency range of sound emission (dB) within which the sound emission (dB) reaches its maximum. Then, a portion of the oil pan 14 from which the loudest sound within that frequency range is generated is determined as the portion with the maximum vibration amplitude. In this embodiment, the frequency of the maximum sound emission (dB) ranges from 2200 Hz to 2650 Hz. Accordingly, the place where the sound emission (dB) within that frequency range is maximum is determined to be the place with the maximum vibration amplitude, and the soft magnet 16b is installed in that place. It is not particularly necessary to determine the place with the maximum vibration amplitude by measuring the sound emission, and the place with the maximum vibration amplitude may be determined by an optical measurement method, for example.

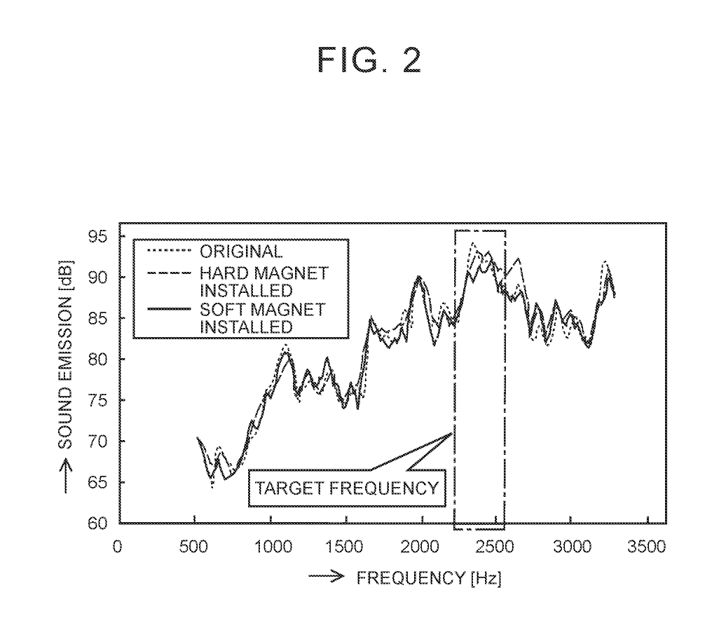

FIG. 2 is a characteristic diagram illustrating the vibration suppressing effect achieved by installing a hard magnet 16a and the soft magnet 16b. In FIG. 2, the graph labeled “Original” represents the value of the frequency characteristics of sound emission measured without the magnet 16 installed. The graph labeled “Hard magnet installed” represents a case where the hard magnet 16a is installed in the portion of the oil pan 14 where the vibration amplitude is maximum. The graph labeled “Soft magnet installed” represents a case where the soft magnet 16b is installed in the portion of the oil pan 14 where the vibration amplitude is maximum. The frequency range from 2200 Hz to 2650 Hz is a range within which the oil pan 14 shows the maximum sound emission when the magnet 16 is not installed, and covers typical frequencies of the vibration generated from the meshing part of the gears. Therefore, this range of frequency will be referred to as a target frequency, and is indicated as “Target frequency” in FIG. 2. Compared with the maximum value of the sound emission (dB) of 93.6 (dB) when the magnet 16 is not installed, the maximum value is effectively reduced to 92.6 (dB) when the hard magnet 16a is installed, and the maximum value is more effectively reduced to 91.6 (dB) when the soft magnet 16b is installed. The frequency range of the sound emission when the magnet 16 is not installed is from 2200 Hz to 2650 Hz.

The hard magnet 16a is a generic term referring to magnets that have a high hardness and undergo little deformation under load, such as ferrite magnets manufactured by sintering and metal magnets manufactured by casting, forging, etc.

Metal magnets are typically made of alnico magnets or rare-earth magnets including samarium-cobalt magnets and neodymium magnets. Such hard magnets 16a made of common materials exhibit a Vickers hardness of about 500 to 650 (HV) and a Young's modulus of about 1×10⁴ to 2×10⁴ (Kgf/mm²). On the other hand, the soft magnet 16b is a generic term referring mainly to magnets that are made of a resin with powder of a magnetic material, such as those mentioned above as the material of the hard magnet 16a, dispersed therein, and that have a comparatively low hardness and undergo comparatively significant deformation under load. Such soft magnets 16b made of common materials exhibit a bending elastic modulus of about 5×10³ (Kgf/mm²) or less and a Rockwell hardness of about 200 (HRM) or less.

Resins composing the soft magnet 16b are classified mainly into rubbers and plastics. Among rubbers, for example, natural rubber, chloroprene rubber, nitrile rubber, butyl rubber, silicone rubber, and chlorinated polyethylene rubber are often used. Among plastics, for example, nylon, epoxy resin, EEA (ethylene ethyl acrylate) resin, PPS (polyphenylene sulfide) resin, PA (polyamide) resin, and PE (polyethylene) resin are often used. Powder of materials composing the hard magnet 16a is commonly used as the magnetic material for imparting a magnetic property to the soft magnet 16b. Examples of typical magnetic materials include ferrite magnets, alnico magnets, and samarium-cobalt magnets and neodymium magnets that are rare-earth magnets. Such a material is dispersed in the resin and the resin is molded to produce the soft magnet 16b.

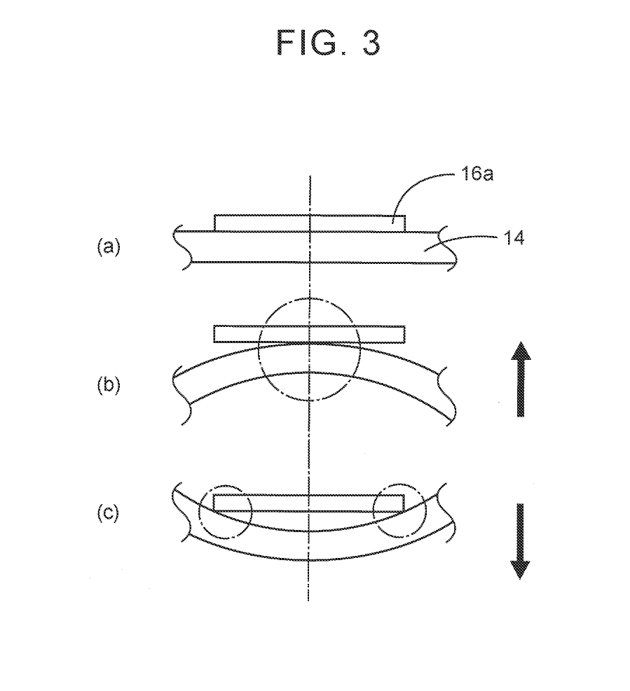

FIG. 3 is a conceptual view illustrating the effect on the reduction of sound emission in the case where the hard magnet 16a is installed on the oil pan 14 of FIG. 1. This conceptual view shows an example in which the hard magnet 16a is installed on the oil pan 14 such that the portion of the oil pan 14 where the vibration amplitude is maximum overlaps the center of the hard magnet 16a. As shown in (a) of FIG. 3, before the vibration of the oil pan 14 is started, the oil pan 14 and the hard magnet 16a are in contact with each other over almost the entire surfaces. When the vibration of the oil pan 14 is started and the oil pan 14 deforms upward in the view as shown in (b) of FIG. 3, only the center of the hard magnet 16a comes into contact with the oil pan 14. When the oil pan 14 deforms downward in the view as shown in (c) of FIG. 3, only both ends of the hard magnet 16a come into contact with the oil pan 14. Thus, as the oil pan 14 deforms, friction occurs between the contact surfaces of the oil pan 14 and both ends of the hard magnet 16a. It is presumed that the sound emission is reduced as part of the vibration energy of the oil pan 14 is consumed by this friction.

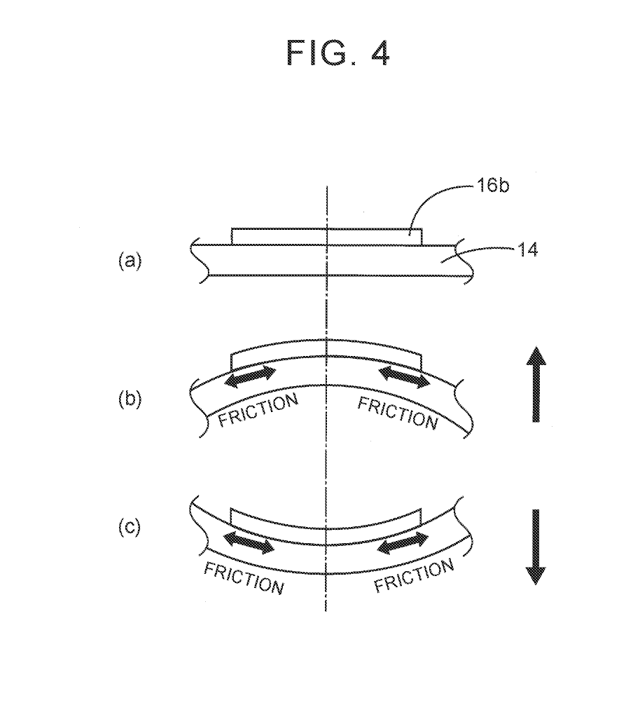

FIG. 4 is a conceptual view illustrating the effect on the reduction of sound emission in the case where the soft magnet 16b is installed on the oil pan 14 of FIG. 1. This conceptual view shows an example in which the soft magnet 16b is installed on the oil pan 14 such that the portion of the oil pan 14 where the vibration amplitude is maximum overlaps the center of the soft magnet 16b. As shown in (a) of FIG. 4, before the vibration of the oil pan 14 is started, the oil pan 14 and the soft magnet 16b are in contact with each other over almost the entire surfaces. When the vibration of the oil pan 14 is started and the oil pan 14 deforms upward in the view as shown in (b) of FIG. 4, the soft magnet 16b remains in contact with the oil pan 14 over a large area, and at the same time causes friction between the contact surfaces as the oil pan 14 deforms. Since the soft magnet 16b has a lower hardness and undergoes more significant deformation under load than the hard magnet 16a, the soft magnet 16b comes into contact with the oil pan 14 over a larger area. The friction force of the friction reaches its maximum at the point when the vibration reaches its maximum, and friction occurs in a direction of spreading the soft magnet 16b at the point when the vibration amplitude of the oil pan 14 approaches its maximum. Then, at the point when the vibration amplitude of the oil pan 14 has passed its maximum and starts to decrease, friction occurs in a direction of narrowing the soft magnet 16b. When the oil pan 14 deforms downward in the view as shown in (c) of FIG. 4, too, friction similar to that of (b) of FIG. 4 occurs, and the friction force reaches its maximum at the point when the vibration amplitude reaches its maximum. Then, at the point when the vibration amplitude of the oil pan 14 approaches its maximum, friction occurs in a direction of spreading the soft magnet 16b. At the point when the vibration amplitude of the oil pan 14 has passed its maximum and the vibration amplitude of the oil pan 14 starts to decrease, friction occurs in a direction of narrowing the soft magnet 16b. It is presumed that the sound emission is reduced as part of the vibration energy of the oil pan 14 is effectively consumed by this friction.

The sound emission reducing effect achieved by installing the soft magnet 16b in the place where the sound emission (dB) is maximum varies according to the bending elastic modulus (Kgf/mm²) and the hardness (HRM) of the soft magnet 16b. It is at a bending elastic modulus of approximately 2500 (Kgf/mm²) or less or a Rockwell hardness of approximately 150 HRM or less that the soft magnet 16b starts to exhibit a difference from the hard magnet 16a in reduction of sound emission.

To further produce the sound emission reducing effect, the soft magnet 16b may have a bending elastic modulus of 1500 (Kgf/mm²) or less or a Rockwell hardness of 100 HRM or less.

To further produce the sound emission reducing effect, the soft magnet 16b may have a bending elastic modulus of 1000 (Kgf/mm²) or less or a Rockwell hardness of 50 HRM or less.

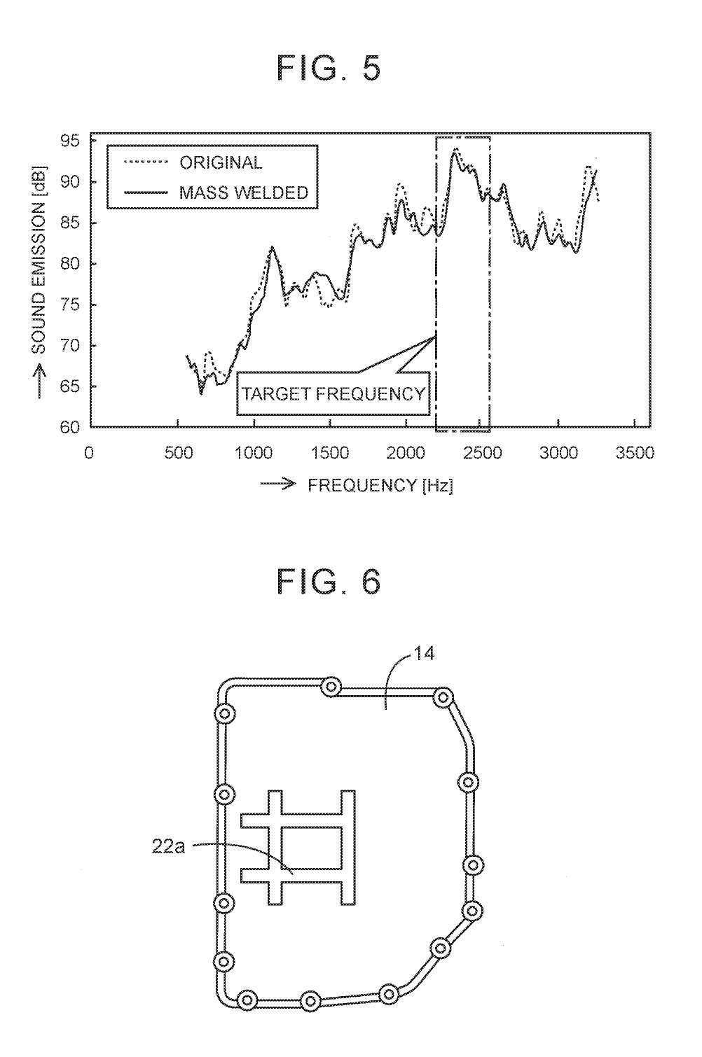

FIG. 5 is a characteristic diagram illustrating a vibration suppressing effect achieved by welding a plate-like metal member, having approximately the same weight as the hard magnet 16a, in the portion of the oil pan 14 where the vibration amplitude is maximum. In FIG. 5, the graph labeled “Original” represents the value of the frequency characteristics of sound emission measured without the magnet 16 installed. The graph labeled “Mass welded” represents a case where the plate-like metal member having approximately the same weight as the hard magnet 16a is welded to the portion of the oil pan 14 where the vibration amplitude is maximum. In the case of “Original”, i.e., in the case where the metal member is not welded, the maximum value of the sound emission (dB) within the range from 2200 Hz to 2650 Hz is 93.6 (dB). In the case where the metal member is welded, the maximum value of the sound emission (dB) within the frequency range from 2200 Hz to 2650 Hz is 93.6 (dB), which is the same as that in the case of “Original,”, i.e., when the metal member is not welded. Thus, it is shown that installing a mass similar to the hard magnet 16a in the vibrating part by welding so as not to move from the oil pan 14 has little sound emission reducing effect.

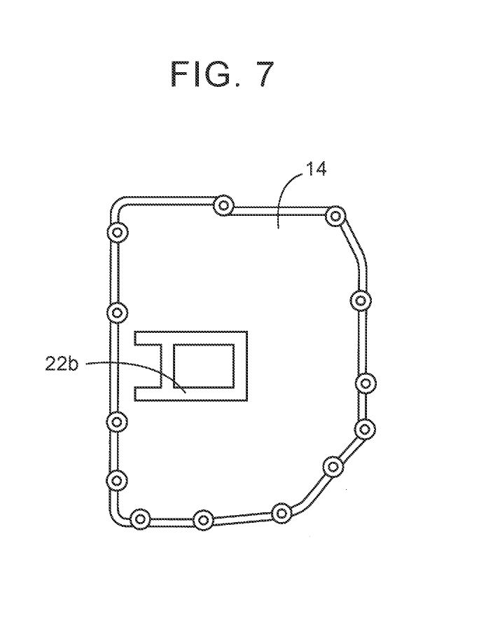

FIG. 6 and FIG. 7 show the oil pan 14 in which band-like protrusions are formed in the portion of the oil pan 14 where the vibration amplitude is maximum. The protrusions are generally referred to as ribs 22a, 22b, and are integrally molded as a part of the external shape of the oil pan 14 when the oil pan 14 is molded by pressing from a metal sheet. In some cases, the ribs are used to improve the rigidity of the metal sheet, and the ribs shown in FIG. 6 and FIG. 7 are formed for the purpose of checking the reduction effect on the sound emission (dB) through the improvement of the rigidity. The frequency range of the sound emission (dB) is 2200 Hz to 2650 Hz. For both the ribs 22a, 22b of FIG. 6 and FIG. 7, one of the intersections of the ribs formed in the horizontal and vertical directions is formed at a position including the portion of the oil pan 14 where the vibration amplitude is maximum. The ribs 22a of FIG. 6 are different in shape from the ribs 22b of FIG. 7 in that the vertical ribs of the ribs 22b are extended beyond the intersections with the horizontal ribs.

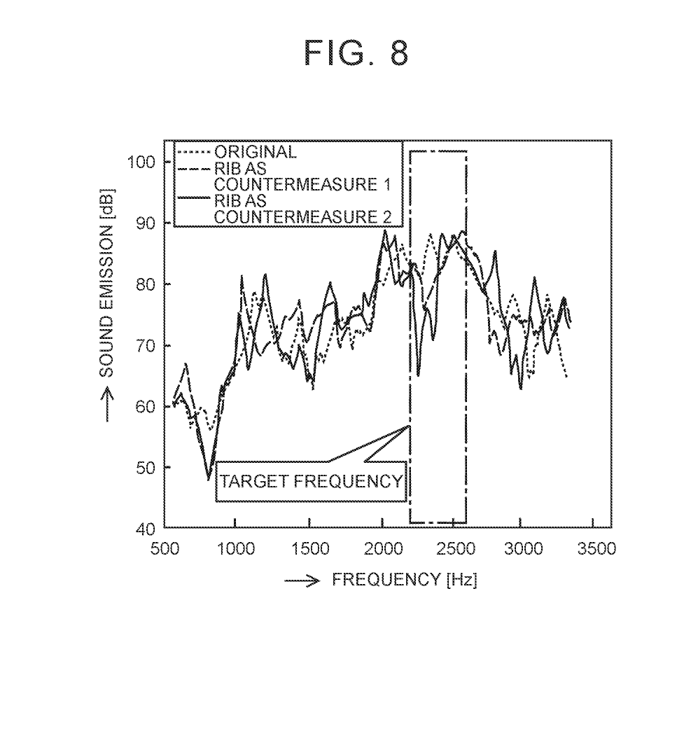

FIG. 8 is a characteristic diagram illustrating the vibration suppressing effect achieved by the ribs 22a, 22b of FIG. 6 and FIG. 7. In FIG. 8, the graph labeled “Original” represents the value of the frequency characteristics of sound emission measured without the ribs installed. The graph labeled “Rib as countermeasure 1” represents the frequency characteristics of the sound emission of the oil pan 14 having the ribs 22a of FIG. 6. The graph labeled “Rib as countermeasure 2” represents the frequency characteristic of the sound emission of the oil pan 14 having the ribs 22b of FIG. 7. The maximum value of the sound emission in the case of “Original”, i.e., in the state where the ribs are not installed is 87.8 dB at 2370 Hz. On the other hand, the maximum value of the sound emission measured under the same conditions in the case of “Rib as countermeasure 1” where the ribs are formed is 88.0 dB at 2115 Hz. Thus, the maximum value is outside the frequency range of 2200 Hz to 2650 Hz and the sound emission is slightly larger than that in the case of “Original”. The maximum value of the sound emission in the case of “Rib as countermeasure 2” is 89.0 dB at 2040 Hz. Thus, the maximum value is outside the frequency range of 2200 Hz to 2650 Hz and the sound emission is slightly larger than that in the case of “Original”. According to these results, therefore, improving the rigidity by the formation of ribs does not lead to a reduction of sound emission but leads to a shift of the frequency of the sound emission at the maximum value to a lower frequency. Thus, it is shown that forming band-like ribs in the portion of the oil pan 14 where the vibration amplitude is maximum has little sound emission reducing effect.

Thus, in the vehicle transmission case 12 of this embodiment, the sound emission from the oil pan 14, which cannot be reduced by improving the rigidity of the oil pan as described above, is effectively reduced by attaching the soft magnet 16b to the oil pan 14 by magnetic attractive force. If the soft magnet 16b is attached to the oil pan 14, the soft magnet 16b vibrates with the oil pan 14, while causing friction with the adhering surface, without entirely integrating with the oil pan 14. Part of the vibration energy of the oil pan 14 is consumed by the friction energy generated in that process. It is presumed that the sound emission from the oil pan 14 is reduced as the vibration of the oil pan 14 is suppressed.

Moreover, since the soft magnet 16b is attached to the inner side of the oil pan 14, even if the soft magnet 16b drops from the installation position of the oil pan 14, the soft magnet 16b remains inside the oil pan 14 structured to store a predetermined amount of oil. Thus, it is unlikely that damage is caused to a device etc. installed outside the transmission 10.

Since the attaching position of the soft magnet 16b includes at least the portion of oil pan 14 where the vibration amplitude is maximum before the soft magnet 16b is attached, significant friction occurs between the soft magnet 16b and the oil pan 14. Thus, the vibration of the oil pan 14 is effectively suppressed and the sound emission from the oil pan 14 is effectively reduced.

Moreover, since the so-called soft magnet 16b produced by dispersing a magnetic material in a resin, mainly rubber or plastic, and molding the resin is installed, significant friction occurs between the soft magnet 16b and the oil pan 14. Thus, the sound emission from the oil pan 14 is reduced more effectively.

It is possible to adjust the bending elastic modulus (Kgf/mm²) and the hardness (HRM) of the soft magnet 16b by adjusting the type and amount of the resin, the type, grain size, and amount of the magnetic material, etc. As to the properties of the soft magnet 16b, the bending elastic modulus may be 2500 (Kgf/mm²) or less or the Rockwell hardness may be HRM 150 or less. Alternatively, the bending elastic modulus may be 1500 (Kgf/mm²) or less or the Rockwell hardness may be HRM 100 or less. Or, the bending elastic modulus may be 1000 (Kgf/mm²) or less or the Rockwell hardness may be HRM 50 or less.

While the embodiment of the present disclosure has been described in detail on the basis of the drawings, the present disclosure are also applicable to other aspects.

For example, in the embodiment, the oil pan 14 is vertical to the bottom surface of the vehicle or horizontal to the bottom surface of the vehicle. However, the present disclosure is not necessarily limited thereto, and the oil pan 14 may form a certain angle with the bottom surface of the vehicle.

It has been described that the place of the oil pan 14 where the vibration amplitude is maximum is determined by measuring the intensity of sound emission (dB) or by an optical method. However, the present disclosure is not necessarily limited thereto. Another method, for example, a method of mechanically measuring the vibration amplitude through contact with the vibrating surface may be used.

It has been described that the resins composing the soft magnet 16b are classified mainly into rubbers and plastics, and that, among rubbers, for example, natural rubber, chloroprene rubber, nitrile rubber, butyl rubber, silicone rubber, and chlorinated polyethylene rubber are used. However, the present disclosure is not particularly limited thereto. It has been described that, among plastics, for example, nylon, epoxy resin, EEA (ethylene ethyl acrylate) resin, PPS (polyphenylene sulfide) resin, PA (polyamide) resin, and PE (polyethylene) resin are used, but the present disclosure is not particularly limited thereto.

It has been described that the magnetic materials that impart a magnetic property to the soft magnet 16b are ferrite magnets, alnico magnets, and samarium-cobalt magnets and neodymium magnets being rare-earth magnets, but the present disclosure is not particularly limited thereto.

It has been described that the part of the oil pan 14 where the soft magnet 16b is installed is a flat surface, but the part does not particularly need to be a flat surface. As long as the soft magnet 16b can effectively suppress the vibration of the oil pan 14, a portion with a curved surface or multiple surfaces, for example, may be formed in the oil pan 14 and the soft magnet 16b may be installed in that portion.

The embodiment is a mere example, and the present disclosure can also be implemented in other aspects with various modifications and improvements made thereto on the basis of the knowledge of those skilled in the art.

What is claimed is:

1. A transmission case housing a gear mechanism that transmits power through the meshing of gears, the transmission case comprising
an oil pan that constitutes a part of the transmission case, the oil pan including a soft magnet in at least one portion of the oil pan, the soft magnet being attached to the oil pan by magnetic attractive force.

2. The transmission case according to claim 1, wherein
the soft magnet is attached to an inner surface of the oil pan.

3. The transmission case according to claim 2, wherein
the soft magnet is attached to a position including at least a predetermined portion of the oil pan, and the predetermined portion is a portion of the oil pan where a vibration amplitude before an installation of the soft magnet is maximum.

4. The transmission case according to claim 1, wherein
the soft magnet is a magnet made of a resin with magnetic powder dispersed in the resin.

5. The transmission case according to claim 4, wherein
the soft magnet is a soft magnet having one of a bending elastic modulus of 2500 Kgf/mm² or less and a Rockwell hardness of HRM 150 or less.

6. The transmission case according to claim 4, wherein
the soft magnet is a soft magnet having one of a bending elastic modulus of 1500 Kgf/mm² or less and a Rockwell hardness of HRM 100 or less.

7. The transmission case according to claim 4, wherein
the soft magnet is a soft magnet having one of a bending elastic modulus of 1000 Kgf/mm² or less and a Rockwell hardness of HRM 50 or less.
